(19) United States
(12) Patent Application Publication
(10) Pub. No.: US 2015/0227996 A1
(43) Pub. Date: Aug. 13, 2015

(54) MAY SHIP HANDLING

(71) Applicants: Alpha Kamchiu Luk, San Jose, CA (US); Jennifer Chang, San Francisco, CA (US); Michael Ching, San Jose, CA (US); Alex Cozzi, San Jose, CA (US); Theodore Citrin, San Francisco, CA (US)

(72) Inventors: Alpha Kamchiu Luk, San Jose, CA (US); Jennifer Chang, San Francisco, CA (US); Michael Ching, San Jose, CA (US); Alex Cozzi, San Jose, CA (US); Theodore Citrin, San Francisco, CA (US)

(73) Assignee: EBAY INC., SAN JOSE, CA (US)

(21) Appl. No.: 14/177,391

(22) Filed: Feb. 11, 2014

(51) Int. Cl. G06Q 30/06; G06Q 10/08

(52) U.S. Cl. CPC G06Q 30/0609; G06Q 10/0831

(57) ABSTRACT

In an example embodiment, e-commerce listings from a database are ranked into a first ranking in accordance with a first ranking scheme. Then a location of a potential buyer is identified. One or more of the listings are identified as may ship listings that a corresponding seller has indicated as pertaining to a good or service that may ship to the location of the potential buyer, without a commitment of shipping to the location of the potential buyer. A position of one or more of the may ship listings in the first ranking may be altered to achieve a second ranking.

### TECHNICAL FIELD

This application relates generally to the field of computer technology and, in a specific example embodiment, to a system and method for handling may ship selling listings.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

There are many instances where a particular seller will not ship to a particular buyer or bidder's location. One common instance is in cross-border transactions, where some circumstances prevent the seller from shipping to a particular area, or at least make such a shipment less desirable (e.g., countries where the item is banned, countries with unreliable postal systems, etc.). Sellers will often list such off-limits locations in their item listing, so that buyers from those locations know not to bid or purchase the item. There are some instances, however, where a seller will not commit entirely to shipping to a particular location but also will not state explicitly that the location is off-limits either. If a seller commits to shipping to a location, this may be known as a “will ship” location. If a seller states explicitly that they will not ship to a location, this may be known as a “won't ship” location. Locations where the seller has not committed one way or another may be known as “may ship” locations.

Items having “may ship” locations in the item listing present a challenge for buyers. If they are interested in the item, they must first contact the seller (usually via email) and inquire as to whether the seller will ship to their location. They must do this even if the odds of the seller actually being willing to ship the item to the location are low. Additionally, if the seller ultimately refuses to ship to the buyer's location, then the system as a whole would have wasted the opportunity to present the buyer with a similar listing from a seller who would have shipped, and ultimately a consummated transaction may have been lost.

### BRIEF DESCRIPTION OF THE DRAWINGS

The present description is illustrated by way of example, and not by way of limitation, in the figures of the accompanying drawings in which:

FIG. 1 is a network diagram depicting a client-server system, within which one example embodiment may be deployed.

FIG. 2 is a block diagram illustrating marketplace and payment applications that, in one example embodiment, are provided as part of application server(s) in the networked system.

FIGS. 3 and 4 are screen captures illustrating a modification of ranked listings based on a may ship aspect, in accordance with an example embodiment.

FIG. 5 is a diagram illustrating an example of various thresholds and actions, in accordance with an example embodiment.

FIG. 6 is a flow diagram illustrating a method of handling a may ship aspect, in accordance with an example embodiment.

FIG. 7 is a block diagram illustrating a mobile device, according to an example embodiment.

FIG. 8 is a block diagram of machine in the example form of a computer system within which instructions, for causing the machine to perform any one or more of the methodologies discussed herein, may be executed.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In various embodiments, may ship handling is described. Various actions may be undertaken for listings having a location listed as “may ship.” In one example embodiment, a potential buyer's location is determined, and listings that list the potential buyer's location as “may ship” are dropped to the end of a series of results presented to the potential buyer. In this manner, a potential buyer will see items that a seller has committed to shipping to the potential buyer's location prior to seeing items that a seller is undecided about. In another example embodiment, the likelihood of the seller being willing to ship to the potential buyer's location is determined, and various actions may be taken based on how likely the seller is to ship to the potential buyer's location.

It should be noted that various embodiments will be described herein pertaining to cross-border transactions. Cross-border transactions involve transactions across legal borders. These borders are often between countries, although there may be instances where intra-country borders may be relevant for shipping purposes (e.g., some states ban the import of alcohol, and in such instances the borders between states may be relevant for shipping purposes). Even in light of the term “border” being interpreted broadly to cover intra-country borders of various granularities, embodiments are foreseen where explicit borders are not a factor. For example, a buyer's location may be relevant not as an absolute location (e.g., California) but as a distance from a particular point (e.g., distance from a seller, distance from a port, distance from an airport, etc.). Additionally, the location may be defined as being within or outside one or more geofences. These geofences may establish area boundaries that are not based on legal boundaries (e.g., areas with high population). In some example embodiments, these geofences may be dynamically determined, as they can be constantly changing (e.g., geofence based on current weather).

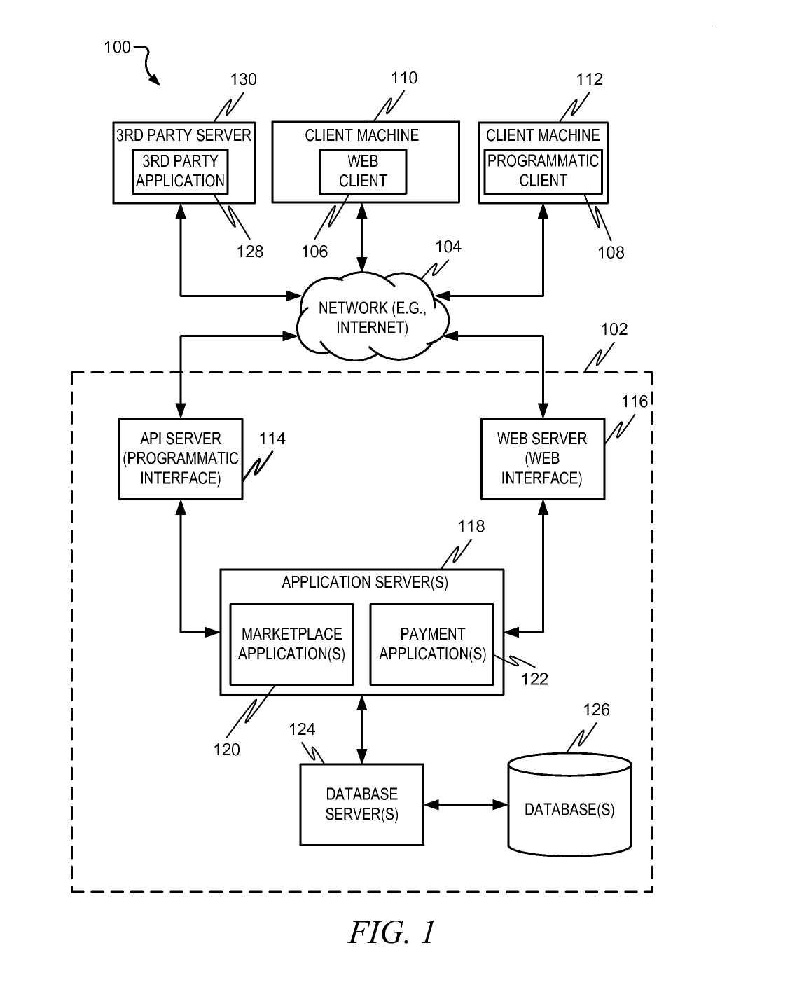

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a wide area network (WAN)), to one or more clients. FIG. 1 illustrates, for example, a web client 106 (e.g., a browser, such as the Internet Explorer® browser developed by Microsoft® Corporation of Redmond, Wash. State) and a programmatic client 108 executing on respective devices 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the Turbo Lister application developed by eBay Inc., of San Jose, Calif.) to enable sellers to author and manage listings on the networked system 102 in an offline manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

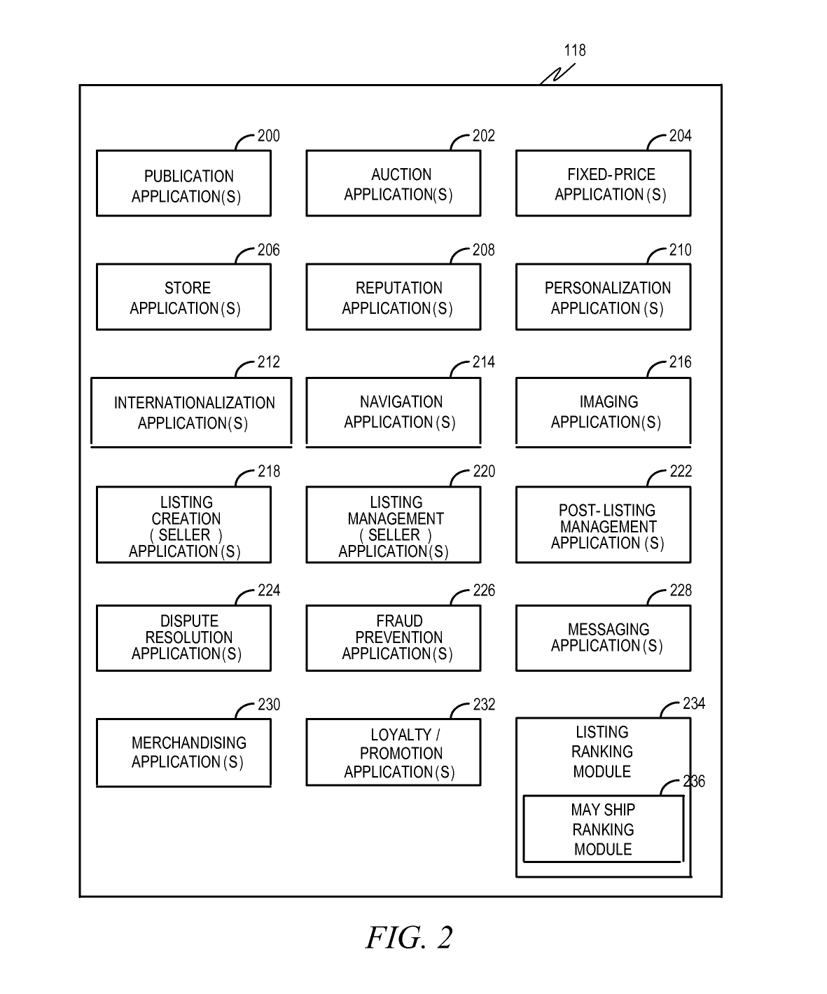

FIG. 2 is a block diagram illustrating marketplace and payment applications 120 and 122 that, in one example embodiment, are provided as part of application server(s) 118 in the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information by the networked system 102) according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. The imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or providing promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks 104.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

In an example embodiment, a listing ranking module 234 may be utilized to rank one or more listings. These listings may be for, e.g., items for sale in an e-commerce service, although other types of listings, such as services for sale, may be used. At some point, a visiting user may be presented with a series of listings and in such cases, the listing ranking module 234 may be utilized to determine a ranking of the potential listings. Typically, the higher ranked the listing, the more predominantly the listing will be displayed. If the listings are presented as a list, the higher ranking listings may be presented at the top of the list, for example, although embodiments are possible where different types of displays based on ranking are utilized (e.g., higher ranked means larger font, icon, or picture).

The listings may be ranked in response to a number of different user actions. In one example, a user may perform a search for items, either by entering keywords into a search box or by navigating to a particular page (e.g., a page dedicated to the car he or she owns). The search results may contain a number of listings. The listing ranking module 234 may rank the listings in accordance with any of a number of different ranking modalities. Examples include rankings based on relevancy of keyword, frequency of appearance of keyword in listing search results, distance between the buyer and seller, price, and so forth. In some instances, the ranking may be based on parameters selected by the user (e.g., the user may prefer to have results ranked in order of price). In an example embodiment, regardless of the ranking modality, the ranked listings are treated as a “first pass” only. A may ship ranking module 236 may then act to modify the initial ranking based on the fact that some of the listings indicate that the sellers “may ship” to the potential buyer's location.

In an example embodiment, the may ship ranking module 236 identifies all ranked listings where the seller has indicated that he or she “may ship” to the potential buyer's location. Then, the may ship ranking module 236 modifies the ranking of the listings so that the “may ship” listings are at the bottom of the ranking.

The potential buyer's location may be determined in a number of different ways. In one example, the potential buyer has logged in and has a profile on record with the ecommerce service that identifies the potential buyer's location (from, for example, a questionnaire filled out by the user, or a saved shipping or billing address). In another example, the potential buyer's location may be dynamically determined using, for example, a global positioning system (GPS) module in a mobile device being used by the user, or by determining an Internet Protocol (IP) address the user is utilizing to access the e-commerce service and performing a lookup to find the general geographic location associated with the IP address.

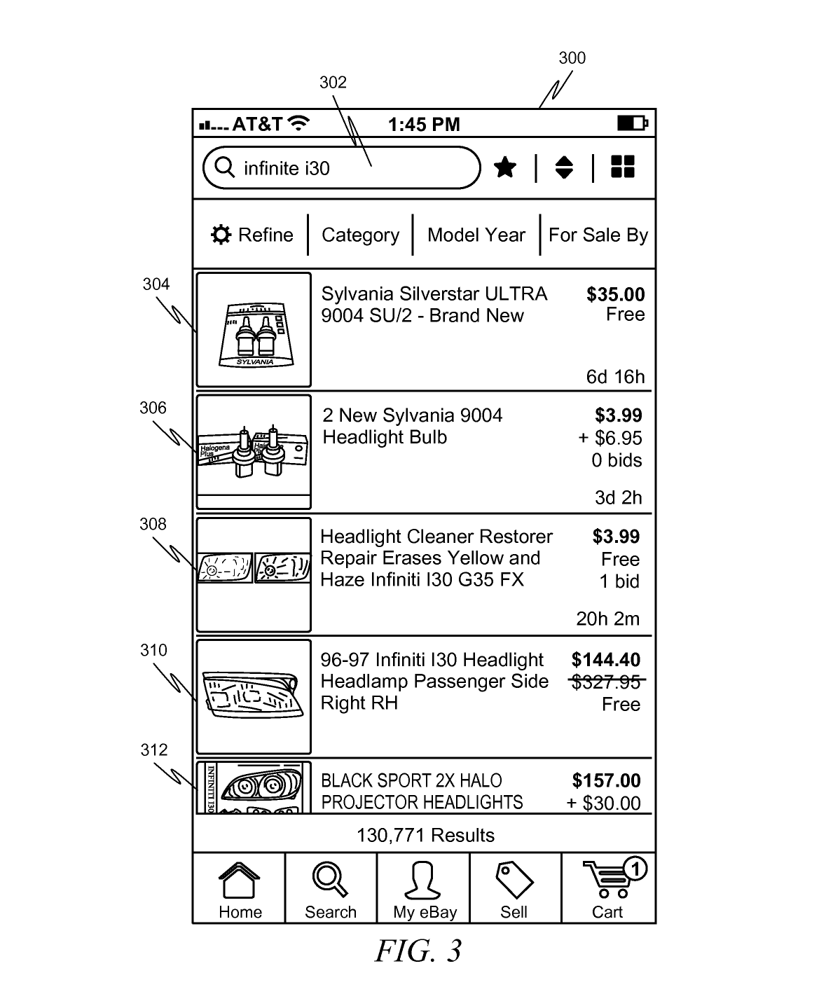

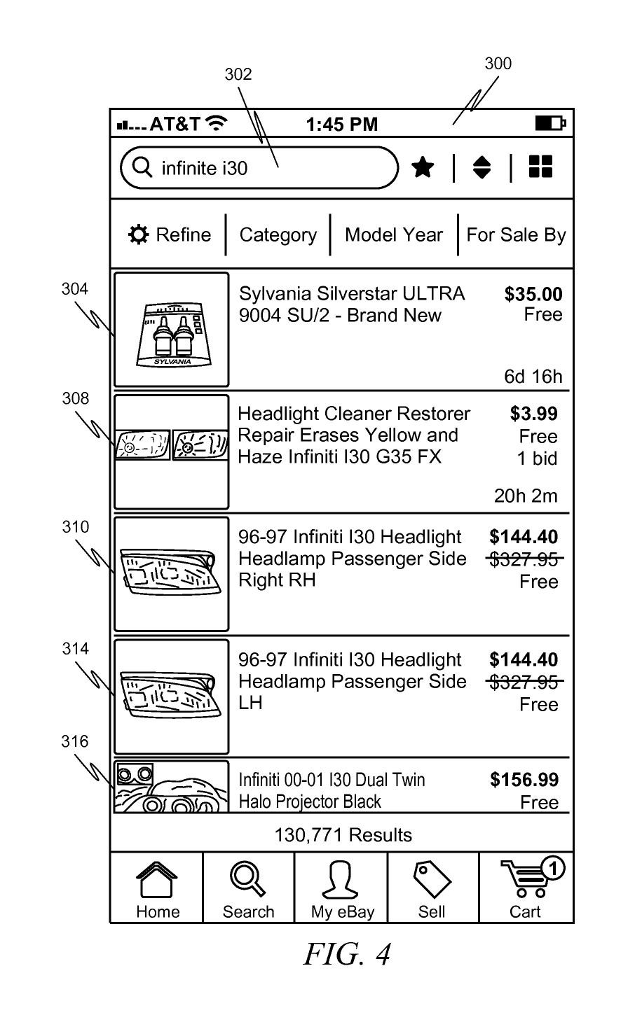

FIGS. 3 and 4 are screen captures illustrating a modification of ranked listings based on a may ship aspect, in accordance with an example embodiment. FIG. 3 represents an ordinary ranking in response to a search. Here, user interface 300 includes a search box 302 and a plurality of item listings 304, 306, 308, 310, and 312 responsive to the input in the search box 302. It should be noted that this screen capture is merely provided to illustrate the initial rankings provided prior to the execution of any may ship aspects, and as such, the plurality of item listings 304, 306, 308, 310, and 312 may never actually be displayed in this order in many embodiments.

In this example, while it is not pictured, item listings 306 and 312 have been labeled as “may ship” by the respective sellers for particular countries. In this example, the potential buyer/viewer is located in one of the countries that these sellers have listed as “may ship” to for these items listings 306 and 312. In other words, it is not certain that the respective sellers would ship the items to the potential buyer/viewer's location. As such, the system bumps these item listings 306 and 312 down to the bottom of the list. FIG. 4 represents a modified ranking after the system has adjusted for the may ship aspect, in accordance with an example embodiment. As can be seen, item listings 306 and 312 are not visible (although they would be visible if the user scrolls down enough to locate the bottom of the ranked listings). Rather, listings 308, 310, 314, and 316 have been bumped up in prominence.

The above example describes a largely binary determination of the may ship status—either the listing is listed as “may ship” to the buyer's location (and it is subsequently bumped down in the rankings) or it is listed as “will ship” (and it remains in its location in the rankings). In an example embodiment, a non-binary approach may be taken. In such an approach, the likelihood that the seller will ship to the buyer's location is determined. Thus, even though the seller may be unsure whether he or she would actually ship the item to the buyer, the system may undertake to deduce whether or not the seller would in fact ultimately agree to ship the item to the buyer.

This deduction may be accomplished in various ways using various pieces of information available to the system. In one example, a seller's sales and shipping history is examined. If, for example, the seller has in the past sold items and shipped them to the same location as the current buyer, the seller may be more likely to agree to ship again. Of course, it is possible that the seller may have had a poor experience with a previous shipment to the location, such as an unreliable mail service in a country losing the shipment, or a buyer expressing remorse and sending the item back. In such cases, the system may examine return and lost/damaged shipment claims from previous transactions involving the seller to determine whether such a situation occurred (if so, it makes it more likely that the seller would, in fact, not ship to the current buyer's location).

In another example, previous transaction histories of other sellers with similar items may be examined. For example, it may be that, due to an import ban, most sellers would never have shipped an item similar to the current item to the buyer's location. While the current seller may have a vague notion that shipping to a certain country is “bad,” and thus they listed the item as “may ship” instead of “will ship,” they may not have undertaken the proper investigation to learn that, in fact, such a ban exists (which, if known, would have caused them to list the item as “won't ship”). In such an instance, the past history of other sellers is able to be used to deduce that these types of items are usually not shipped to this particular location, and thus the system may deduce that the likelihood that the seller would ship to the location is low.

Other factors may also influence whether a seller is likely to ship to a particular buyer's location. For example, the price of the item may influence the seller's likelihood (e.g., they may not feel it is worth the added burden of shipping to this foreign country unless the price of the item is high). In another example, the size of the item may have influence.

In an example embodiment, a likelihood of shipment score may be calculated for a particular listing and particular buyer location. This may be calculated using one or more of the various pieces of information available to the system, such as those described above. The score may then be compared with one or more thresholds. The thresholds may determine the action or actions taken with respect to reordering the particular listing in the ranked listings.

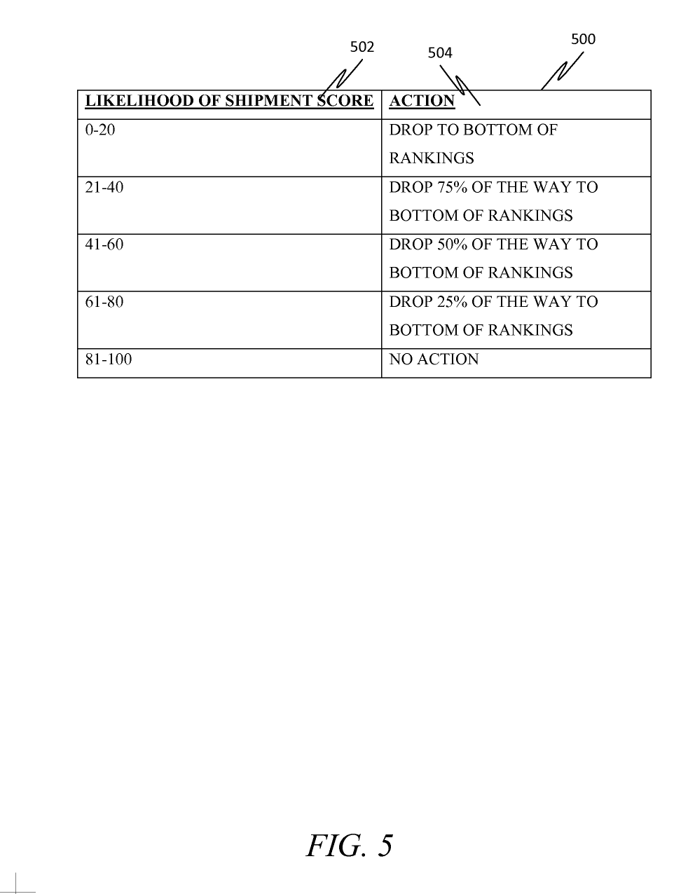

FIG. 5 is a diagram illustrating an example of various thresholds and actions, in accordance with an example embodiment. Here, a score of 0-100 may be assigned as the likelihood of shipment score for a particular listing/buyer location pair. Table 500 contains a score column 502 and an action column 504. As can be seen, scores between 0-20 result in the listing being dropped to the bottom of the rankings, scores between 21-40 result in the listing being dropped 75% of the way to the bottom of the ranking, scores between 41-60 result in the listing being dropped 50% of the way to the bottom of the ranking, scores between 61-80 result in the listing being dropped 25% of the way to the bottom of the ranking, and scores between 81-100 result in no action (e.g., the listing remains at the same ranking as before). Of course, various levels of dropping the ranking are only one example of actions that can be taken with respect to the listing. Other examples include decreasing the size of the listing, deemphasizing the color of the listing, changing the font of the listings, and so forth.

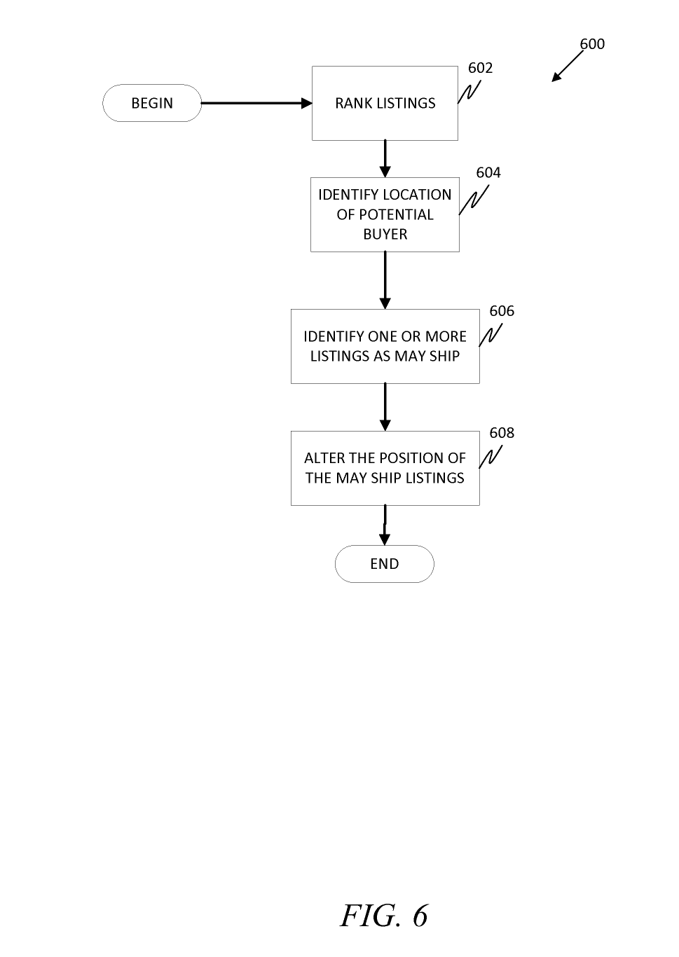

FIG. 6 is a flow diagram illustrating a method 600 of handling a may ship aspect, in accordance with an example embodiment. At operation 602, e-commerce listings from a database may be ranked into a first ranking in accordance with a first ranking scheme. At operation 604, a location of a potential buyer may be identified. At operation 606, one or more of the listings may be identified as may ship listings that a corresponding seller has indicated as pertaining to a good or service that may ship to the location of the potential buyer, without a commitment of shipping to the location of the potential buyer. At operation 608, a position of one or more of the may ship listings in the first ranking may be altered to achieve a second ranking.

### Example Mobile Device

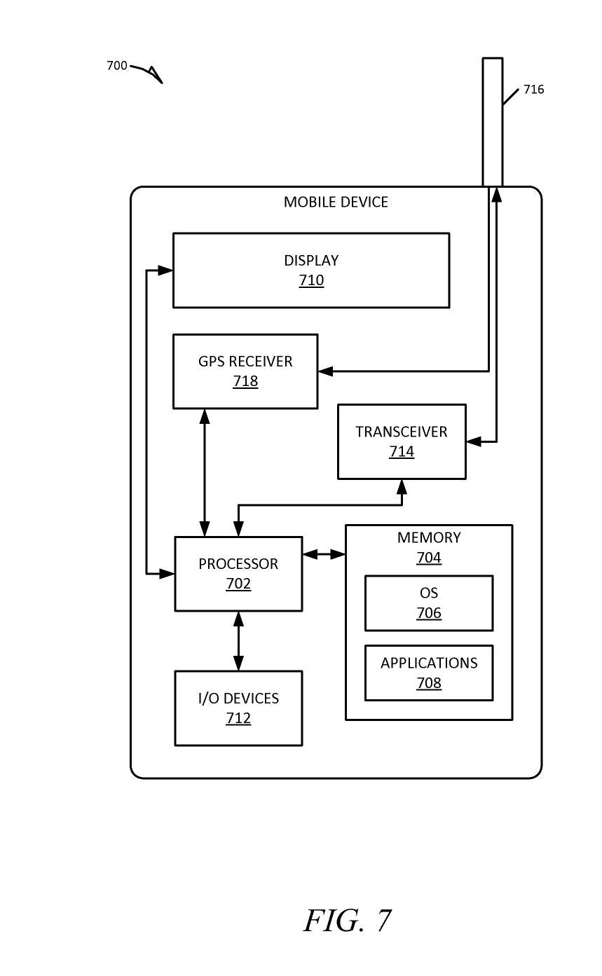

FIG. 7 is a block diagram illustrating a mobile device 700, according to an example embodiment. The mobile device 700 may include a processor 702. The processor 702 may be any of a variety of different types of commercially available processors suitable for mobile devices (for example, an XScale architecture microprocessor, a Microprocessor without Interlocked Pipeline Stages (MIPS) architecture processor, or another type of processor). A memory 704, such as a random access memory (RAM), a Flash memory, or other type of memory, is typically accessible to the processor. The memory 704 may be adapted to store an operating system (OS) 706, as well as application programs 708, such as a mobile location enabled application that may provide Location Based Services (LBSs) to a user. The processor 702 may be coupled, either directly or via appropriate intermediary hardware, to a display 710 and to one or more input/output (I/O) devices 712, such as a keypad, a touch panel sensor, a microphone, and the like. Similarly, in some embodiments, the processor 702 may be coupled to a transceiver 714 that interfaces with an antenna 716. The transceiver 714 may be configured to both transmit and receive cellular network signals, wireless data signals, or other types of signals via the antenna 716, depending on the nature of the mobile device 700. Further, in some configurations, a GPS receiver 718 may also make use of the antenna 716 to receive GPS signals.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one of processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs.)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

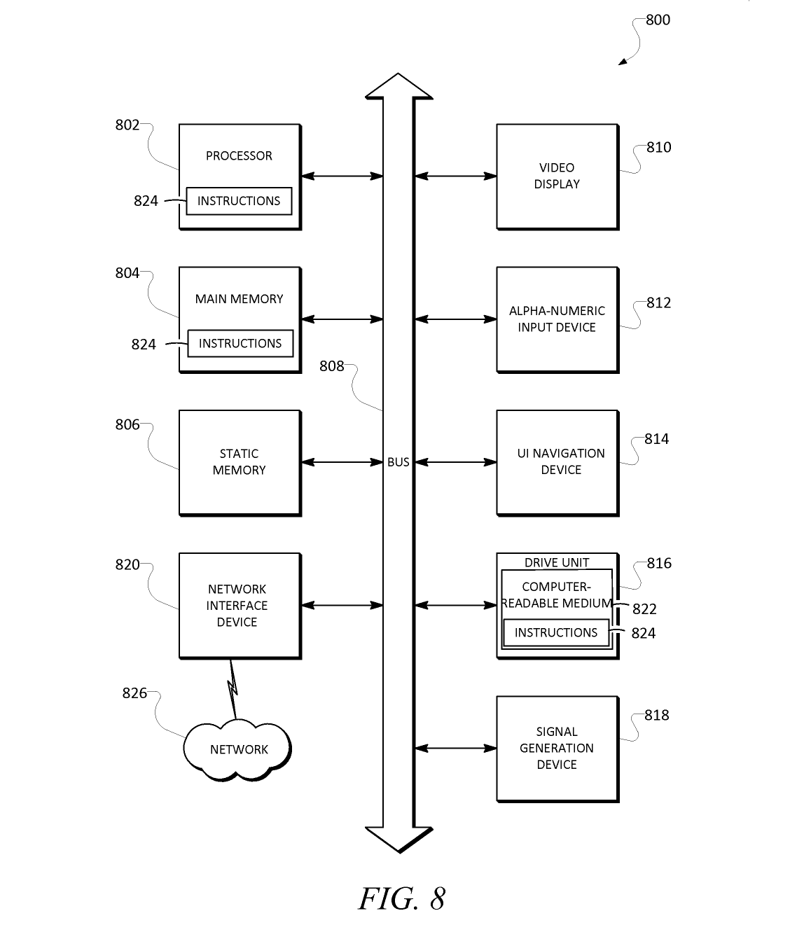

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An e-commerce system comprising:
a marketplace application executable by a processor and configured to access listings from a database;
a listing ranking module configured to rank the listings from the database into a first ranking in accordance with a first ranking scheme, the listing ranking module including a may ship ranking module configured to:
identify a location of a potential buyer;
identify one or more of the listings as may ship listings that a corresponding seller has indicated as pertaining to a good or service that may ship to the location of the potential buyer, without a commitment of shipping to the location of the potential buyer; and
alter a position of one or more of the may ship listings in the first ranking to achieve a second ranking.

2. The e-commerce system of claim 1, wherein the altering a position includes dropping the one or more of the may ship listings to a bottom of the second ranking.

3. The e-commerce system of claim 1, wherein the altering a position results in the one or more of the may ship listings being displayed less prominently using the second ranking than they would have using the first ranking.

4. The e-commerce system of claim 1, wherein the may ship ranking module is further configured to calculate a likelihood of shipment score for at least one of the may ship listings in combination with information about the potential buyer.

5. The e-commerce system of claim 4, wherein the likelihood of shipment score is calculated using past transaction information from a seller corresponding to the at least one of the may ship listings.

6. The e-commerce system of claim 4, wherein the likelihood of shipment score is calculated using past transaction information from sellers of similar items to one or more items being sold in the at least one may ship listing.

7. The e-commerce system of claim 4, further comprising comparing the likelihood of shipment score for a particular may ship listing to one or more thresholds to determine how to alter the position of the may ship listing to achieve the second ranking.

8. A method comprising:
ranking e-commerce listings from a database into a first ranking in accordance with a first ranking scheme;
identifying a location of a potential buyer;
identifying one or more of the listings as may ship listings that a corresponding seller has indicated as pertaining to a good or service that may ship to the location of the potential buyer, without a commitment of shipping to the location of the potential buyer; and
altering a position of one or more of the may ship listings in the first ranking to achieve a second ranking.

9. The method of claim 8, wherein the altering a position includes dropping the one or more of the may ship listings to a bottom of the second ranking.

10. The method of claim 8, wherein the altering a position results in the one or more of the may ship listings being displayed less prominently using the second ranking than they would have using the first ranking.

11. The method of claim 8, wherein the may ship ranking module is further configured to calculate a likelihood of shipment score for at least one of the may ship listings in combination with information about the potential buyer.

12. The method of claim 11, wherein the likelihood of shipment score is calculated using past transaction information from a seller corresponding to the at least one of the may ship listings.

13. The method of claim 11, wherein the likelihood of shipment score is calculated using past transaction information from sellers of similar items to one or more items being sold in the at least one may ship listing.

14. The method of claim 11, further comprising comparing the likelihood of shipment score for a particular may ship listing to one or more thresholds to determine how to alter the position of the may ship listing to achieve the second ranking.

15. A non-transitory machine-readable storage medium comprising instructions, which when implemented by one or more machines, cause the one or more machines to perform operations comprising:
ranking e-commerce listings from a database into a first ranking in accordance with a first ranking scheme;
identifying a location of a potential buyer;
identifying one or more of the listings as may ship listings that a corresponding seller has indicated as pertaining to a good or service that may ship to the location of the potential buyer, without a commitment of shipping to the location of the potential buyer; and
altering a position of one or more of the may ship listings in the first ranking to achieve a second ranking.

16. The non-transitory machine-readable storage medium of claim 15, wherein the altering a position includes dropping the one or more of the may ship listings to a bottom of the second ranking.

17. The non-transitory machine-readable storage medium of claim 15, wherein the altering a position results in the one or more of the may ship listings being displayed less prominently using the second ranking than they would have using the first ranking.

18. The non-transitory machine-readable storage medium of claim 15, wherein the may ship ranking module is further configured to calculate a likelihood of shipment score for at least one of the may ship listings in combination with information about the potential buyer.

19. The non-transitory machine-readable storage medium of claim 18, wherein the likelihood of shipment score is calculated using past transaction information from a seller corresponding to the at least one of the may ship listings.

20. The non-transitory machine-readable storage medium of claim 18, wherein the likelihood of shipment score is calculated using past transaction information from sellers of similar items to one or more items being sold in the at least one may ship listing.
